(19) United States
(12) Patent Application Publication
(10) Pub. No.: US 2014/0349261 A1
(43) Pub. Date: Nov. 27, 2014

(54) THERAPEUTIC VIDEO GAME DEVICE AND METHOD

(71) Applicant: PERSONAL ZEN VENTURES, LLC, New York, NY (US)

(72) Inventors: Tracy Dennis, New York, NY (US); Shawn Feeney, Oakland, CA (US); Sam Kaufman, San Francisco, CA (US)

(73) Assignee: PERSONAL ZEN VENTURES, LLC

(21) Appl. No.: 14/285,453

(22) Filed: May 22, 2014

Related U.S. Application Data
(60) Provisional application No. 61/826,210, filed on May 22, 2013.

(51) Int. Cl. G09B 5/02

(52) U.S. Cl. CPC G09B 5/02
USPC 434/236

(57) ABSTRACT

A therapeutic video game device and method for cognitive bias modification wherein the video game presents negative and positive stimuli in two discrete areas and repeatedly focuses the user's attention away from the negative stimulus by providing a series of objectives which require the user to input commands into an input means to affect the video game environment in an area away from the negative stimulus. The repeated focus of the user's attention away from the negative stimulus results in a decrease in cognitive bias to negative behaviors such as anxiety, stress, depression, addiction, eating disorders, lack of exercise, and lack of self-esteem. The video game provides an engaging, enjoyable experience for the user.

### CROSS REFERENCE TO RELATED APPLICATION

This application claims the benefit of U.S. Provisional Application No. 61/826,210, filed May 22, 2013, the entire contents of which are hereby incorporated by reference, as if fully contained herein.

### FIELD OF THE INVENTION

This invention relates generally to a therapeutic video game device and method for treating anxiety, addiction, depression, eating disorders, lack of exercise, lack of self-esteem and other negative behaviors.

### BACKGROUND OF THE INVENTION

Anxiety disorders are widespread mental health problems affecting approximately 273 million people globally. In the United States alone, it is estimated that roughly 11-18 percent of the adult population suffer from an anxiety disorder in any given year.

“Threat bias” is an exaggerated attention to threat. The existence of threat bias in an individual can be a cause of anxiety and stress. The lowering of a user's threat bias results in a decrease in anxiety and stress.

Anxiety disorders are often treated by pharmaceuticals, such as selective serotonin reuptake inhibitors (SSRIs). However, SSRI's are costly and pose numerous adverse side effects. Accordingly, it is particularly desirous to provide effective, non-pharmaceutical treatments for anxiety.

Attention Bias Modification Treatment (ABMT) has been developed to treat anxiety without administration of pharmaceuticals. One known form of attention bias modification treatment uses a “dot probe” test to perform attention bias modification treatment. In a dot probe test, users are simultaneously exposed to a threatening and a nonthreatening stimulus in two separate locations for approximately 500 ms. Once the threatening and nonthreatening stimuli disappear, an unemotional probe is immediately displayed in one of these two separate locations and the user is required to identify the location of the probe.

In conventional dot probe testing, the probe is equally likely to be displayed in the area where the threatening stimulus was displayed as in the area where the nonthreatening stimulus was displayed. A user suffering from anxiety is expected to have a faster response for identifying the probe when the probe is positioned in the area showing the threatening stimulus due to an increased attention to the threatening image and difficulty disengaging with the threatening stimulus.

In a known variation of ABMT, the dot probe testing is presented wherein the probe is displayed more frequently in the area where the nonthreatening stimulus was displayed. The recurring display of both threatening and nonthreatening stimuli with an increase in the proportion of the dot probe appearing in the area opposite of the individual's attention bias has been shown to reduce the user's threat bias. This results in a lowering of the user's anxiety and stress.

U.S. Patent Application Publication No. US2011/0027765A1 to Nader teaches a computerized version of the dot probe test wherein the user is presented with a neutral and a negative stimulus, and the patient is prompted to interact with the system by inputting a response limited to one of two choices given to the patient. The response is intended to correlate with a previously displayed image. In certain embodiments, after display of a negative and a neutral stimulus, the letter “E” or “F” is displayed and the user is required to then input an action identifying that letter such as by click of a mouse or typing on the keyboard.

There are a number of drawbacks associated with the known techniques as described herein, and there exists the need to improve upon such techniques and overcome the drawbacks associated therewith.

### SUMMARY OF INVENTION

While ABMT has proven to be an effective treatment for anxiety, ABMT using dot probe testing either in its conventional form or on a computer as referred in U.S. Publication No. 2011/0027765 to Nader is dull and not engaging to the user who is keenly aware that he or she is participating in a psychological test or therapy. Furthermore, the dot probe testing often requires special machinery that is controlled or supervised by a clinician in a formal laboratory setting. Accordingly, it is desired to have a therapeutic device and method which effectively administers ABMT while engaging the user in an enjoyable, immersive game experience wherein the user does not feel like he or she is in a psychological therapy environment and obtains pleasure from using the therapeutic device.

Video games have been a popular form of entertainment for over thirty years. In a video game, a series of images are displayed which represent an environment and typically at least one object that interacts with the environment. The images are usually accompanied by a variety of audio or sound effects. The user is then required to manipulate the screen by input means such as a joystick, controller, body movement that is captured by a video camera, or by hand gestures inputted on a touch screen. The theme and objects of conventional video games often require the user to focus on threatening stimuli displayed on the screen and to combat or escape from the threatening stimuli in one form or another. The focusing of the user's attention on a threatening stimulus in the gameplay of most popular video games increases a user's threat bias and his/her general level of anxiety. However, it is desired to create a video game that reduces anxiety by lowering the user's threat bias while still remaining engaging and pleasurable.

Accordingly, the present invention provides a therapeutic video game device that can be engaging and enjoyable for the user and reduces the user's threat bias in order to decrease the user's stress level and anxiety.

The present invention further provides an engaging and enjoyable therapeutic video game device that can reduce a user's cognitive bias to other types of negative behavior. For example, the present invention can be used for treating one or more of depression, addiction, eating disorders, lack of exercise, lack of self-esteem and other types of negative behavior by reducing a user's cognitive bias to negative stimuli associated with these behaviors and by simultaneously directing the user's cognitive bias to positive stimuli that oppose these negative behaviors.

The present invention further provides a therapeutic video game device that is engaging and enjoyable for the user and that can reduce the user's susceptibility to stress, anxiety, depression, addiction, eating disorders, lack of exercise, lack of self-esteem and other types of negative behavior by reducing any current cognitive bias toward negative behavior experienced by the user and decreasing the likelihood of the user developing cognitive biases to negative behaviors in the future.

The present invention also provides a method for providing a therapeutic video game device that can be engaging and enjoyable for the user and that can reduce the user's cognitive bias to negative behaviors in order to decrease the user's anxiety, stress, depression, addiction, eating disorders, lack of exercise, lack of self-esteem and other negative behaviors and reduce the likelihood of the user developing a cognitive bias to such negative behaviors in the future.

The present invention also provides a computer-readable medium storing a program, which, when executed by a processor, provides a therapeutic video game device that can be engaging and enjoyable for the user and reduces the user's cognitive bias to negative behaviors in order to decrease the user's anxiety, stress, depression, addiction, eating disorders, lack of exercise, lack of self-esteem and other negative behaviors and reduce the likelihood of the user developing a cognitive bias to such negative behaviors in the future.

In accordance with another aspect of the invention, there is provided a method implemented on a computer having a processor and a data storage means for providing a therapeutic video game device that is engaging and enjoyable for the user and which can reduce the user's cognitive bias to negative behaviors in order to decrease the user's anxiety, stress, depression, addiction, eating disorders, lack of exercise, lack of self-esteem and other negative behaviors and reduce the likelihood of the user developing a cognitive bias to such negative behaviors in the future.

In accordance with yet another aspect of the invention, there is provided a non-transitory computer-readable medium storing a program which, when executed by at least one processor, provides a therapeutic video game device that can be engaging and enjoyable for the user and reduces the user's cognitive bias to negative behaviors in order to decrease the user's anxiety, stress, depression, addiction, eating disorders, lack of exercise, lack of self-esteem and other negative behaviors and reduce the likelihood of the user developing a cognitive bias to such negative behaviors in the future.

In accordance with yet another aspect of the invention, there is provided a therapeutic device comprising a computer having input means and a computer display. Software executes on the computer which provides a video game that is programmed to display a series of images representing an environment, wherein the software is adapted to change the display of the video game in accordance with the user's input of a command with the input means. The software is programmed to simultaneously display a depiction of a negative stimulus in a first region of the computer display and a positive stimulus in a second region of the computer display. The software provides a series of objectives the user is required to meet within the video game such that the user is required to perform at least one action with the input means in the immediate vicinity of the second region of the display. The video game objectives, however, do not require the user to perform any video game actions with the input means in the immediate vicinity of the first region of the display. Playing of the video game therefore results in a decrease of the user's cognitive bias to a negative behavior.

In accordance with yet another aspect of the invention, a method comprises providing a video game for a computerized device that is programmed to display a series of images representing an environment and providing input means which allow the user to input a command to the computerized device and the computerized device is adapted to change the display of the video game in accordance with the user's command. Next, a depiction of a negative stimulus is displayed in a first region of the computer display and a positive stimulus is displayed in a second region of the computer display. Then, a series of objectives are provided for the user to meet within the video game by using input means; said objectives require the user to perform at least one video game action in the immediate vicinity of the second region of the display and the video game objectives do not require any video game actions to be performed in the immediate vicinity of the first portion of the display.

In accordance with yet another aspect of the invention, a non-transitory computer-readable medium storing a program, which, when executed by at least one processor, causes the at least one processor to perform the steps according to the method above.

### BRIEF DESCRIPTION OF THE DRAWINGS

The features and advantages of the present invention will be more readily understood from a detailed description of the exemplary embodiments taken in conjunction with the following figures in which:

FIG. 1 shows one specific embodiment of the device according to the present invention wherein threatening and nonthreatening stimuli are displayed in two separate regions of the video game environment.

FIG. 2 shows one specific embodiment of the device according to the present invention showing two holes in the regions where the threatening and nonthreatening stimuli were displayed and a trail of grass extending from a hole where the nonthreatening image was displayed.

FIG. 3 shows an example computer system for implementing the functionality described herein.

FIG. 4 shows a flow chart of the present invention according to one embodiment.

FIG. 5 shows the first embodiment according to the present invention wherein threatening and nonthreatening stimuli are displayed in two separate regions of the video game environment.

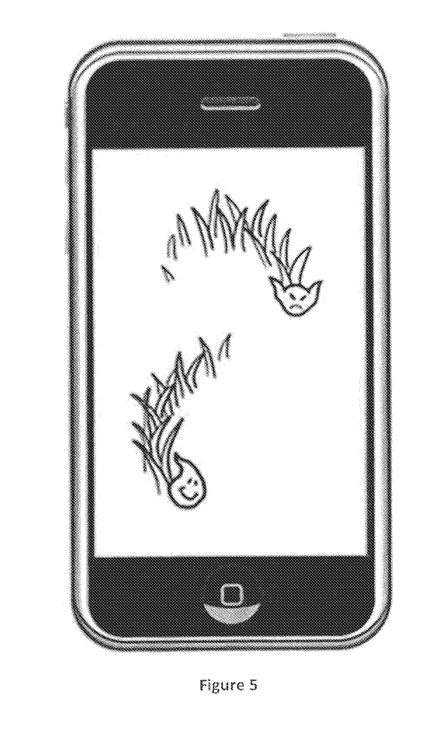

FIG. 6 shows another embodiment according to the present invention.

FIG. 7 shows another embodiment according to the present invention.

FIG. 8 shows another embodiment according to the present invention.

FIG. 9 shows another embodiment according to the present invention.

FIG. 10 shows another embodiment according to the present invention.

FIG. 11 shows another embodiment according to the present invention.

### DETAILED DESCRIPTION OF THE PREFERRED EMBODIMENTS

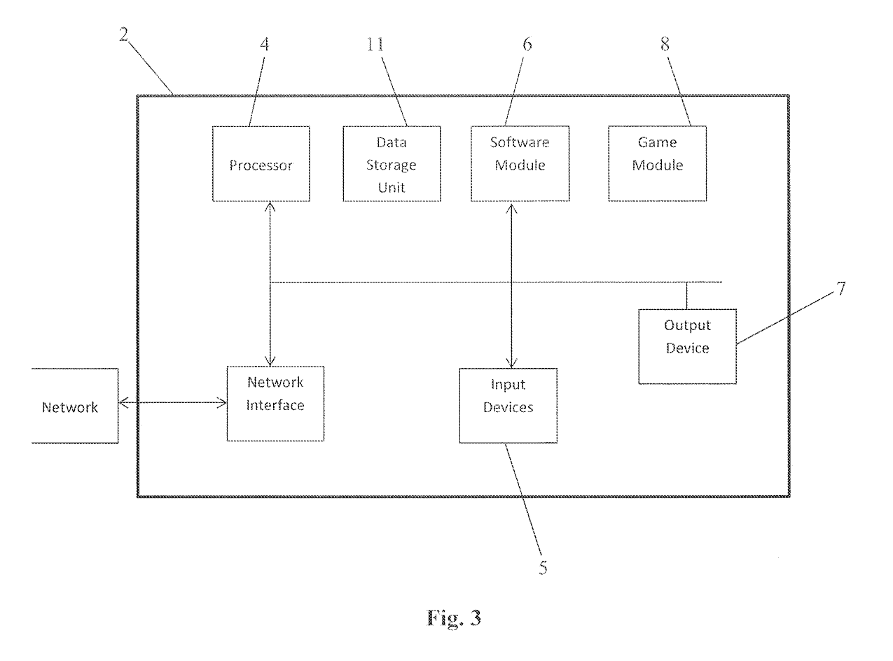

The present invention is particularly directed to an improved device 2 and method 3 for treating one or more of anxiety, stress, depression, addiction, eating disorders, lack of exercise, lack of self-esteem and other negative behaviors by use of a therapeutic, interactive video game. As shown in FIG. 3, the device 2 comprises a computer that is adapted to be able to run software 6 which provides a therapeutic video game. The device 2 includes a data storage unit 11 and at least one processor 4. In a preferred embodiment, the device is a personal computer which receives and carries out instructions for implementing the present invention. The device 2 is preferably a smartphone or a portable computing or gaming device running a computer program or an app implementing the present invention. For instance, the device 2 may be an IPHONE, IPAD, IPOD TOUCH, tablet, notebook, personal computer, portable video game system, an ANDROID smartphone, etc. However, in alternative embodiments, the device may be a standalone computerized device including a data storage unit, a processor, and programmed instructions. Of course, these are just examples and the present invention is not limited thereto.

The device 2 includes input means 5 to allow the user to input video game commands to the device 2. The device 2 or computer receives the commands from the input means or devices 5 and the software module 6 is adapted to change the display of the video game in accordance with the user's specific command. The input means 5 may comprise a joystick, controller, body movement that is optically captured by a video camera, hand gestures inputted on a touch screen, voice control, or any other input means known in the art.

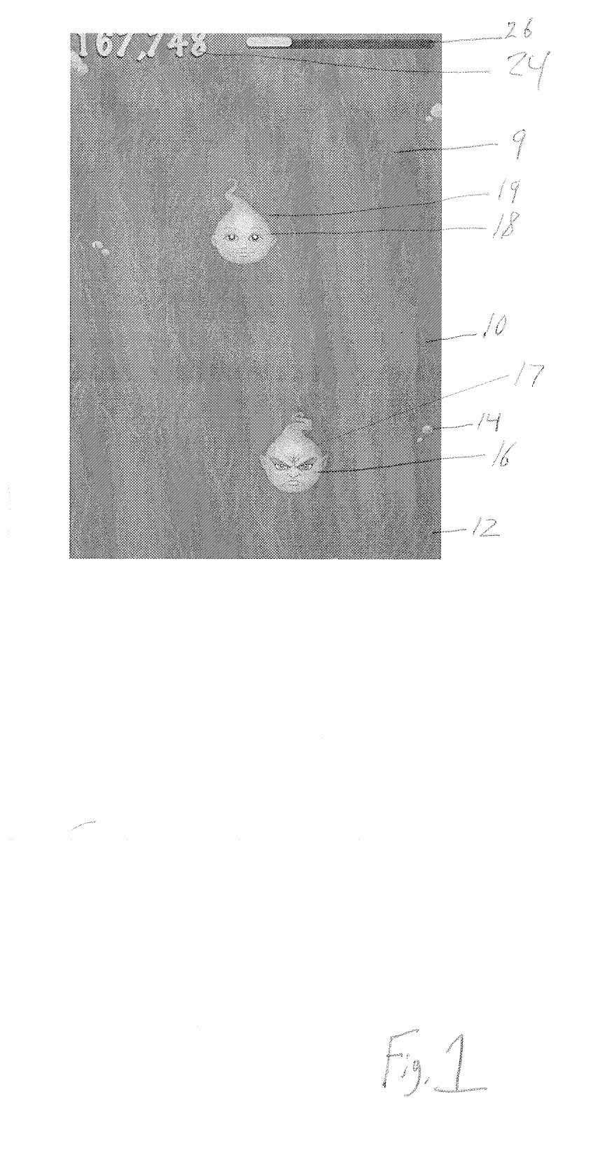

The video game or game module 8 is programmed to display a series of images representing a virtual environment 9 (see, e.g., FIG. 1). The environment 9 and objects provided can represent a countless variety of themes and comprise images having appearances or indicia representative of such themes. The video game may incorporate various stories and plots by the display of such images as well as optional text, sounds, and music. The display of the series of images and other media is intended to create an entertaining and enjoyable video game and therapeutic tool which enables the user to shift and maintain his or her focus on the video game.

There are many objectives that a game experience should strive to achieve. For example, a game experience should be fun, relaxing, encouraging of quick prompt reaction, keep the user engaged over time, implement the scientific principles of Attention Bias Modification Treatment (ABMT), and more. In regard to ABMT, the game experience will need to include both a positive and negative stimulus. As mentioned above, the present invention is directed to treating one or more of anxiety, stress, depression, addiction, eating disorders, lack of exercise, lack of self-esteem and other negative behaviors. Therefore, a positive stimulus should be associated with something that is antithetical to anxiety, stress, depression, addiction, eating disorders, lack of exercise, lack of self-esteem and any other negative behavior. In contrast, a negative stimulus should be associated with something that is representative of the negative behavior that is sought to be treated. For example, if the video game is designed for treating anxiety, the positive stimulus can be a non-threatening image and the negative stimulus can be a threatening image.

A first embodiment of a therapeutic video game is shown in FIG. 1 where the environment 9 consists of a dark shaded background representing a field of grass 10 and lighter shaded strands representing blades of grass 12. Additional images such as rocks 14 can be added to give the environment a more realistic presentation. This first embodiment of the video game 8 is not limited to this virtual environment as there are a plurality of environments and elements that may be presented for providing the therapeutic effect of reducing the user's cognitive bias to negative behavior for reducing the user's anxiety, stress, depression, addiction, eating disorders, lack of exercise, lack of self-esteem and other negative behaviors.

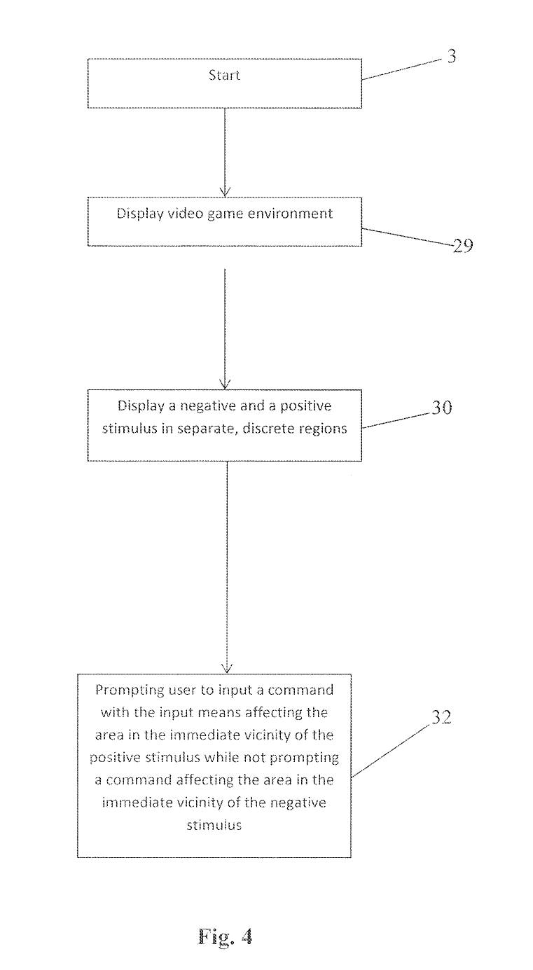

FIG. 4 is a flowchart illustrating a method of the present invention according to the first embodiment that can be implemented by the device 2 of FIG. 3 including the software module 6 and the game module 8 in conjunction with the processor(s) 4 and data storage unit 11. As shown in FIG. 4, a video game environment is displayed (step 29). Then the video game simultaneously displays (step 30) a depiction of a negative stimulus 16 in a first region 17 of the environment and a depiction of a positive stimulus 18 in a second region 19 of the environment. The display of the negative and positive stimuli is preferably presented for a period of approximately 500 ms. The negative and positive stimuli may also be displayed for, e.g., a period of time greater than 500 ms, or other time periods.

In this first embodiment, if the video game is designed for treating anxiety, the negative stimulus 16 is preferably an image that is threatening and that causes a degree of fear in the user. For instance, in the example in FIG. 1, the negative stimulus 16 comprises a cartoon rendition of a sprite with a scowl on its face. However, the negative stimulus 16 can be any other image that can create a desired level of fear in the user and may be tailored to the culture, age, pathology or other characteristics of the intended users. The positive stimulus 18 may be an image that invokes a degree of happiness in the user or at least provides a neutral emotional reaction to the user. In the example in FIG. 1, the positive stimulus 18 comprises a cartoon rendition of a sprite having a smiling face.

The first and second regions 17, 19 where the negative stimulus and positive stimulus 16, 18 are displayed must be two spatially discrete areas of the display or other output means 7. In certain embodiments, the locations of the first and second regions 17, 19 where the negative and positive stimulus 16, 18 are displayed are continuously varied throughout the video game. Therefore, the user cannot anticipate where the negative or positive stimuli will be displayed based on the prior presentation and the user must continually observe the negative and positive stimuli as they are displayed to identify which stimulus is positive.

While the negative and positive stimulus 16, 18 are typically displayed temporarily, in this embodiment of the present invention the negative and positive stimuli may be displayed on the screen for long periods of time or may be permanently fixed on the display or other output means 7 throughout this embodiment of the videogame.

As shown in step 32 of FIG. 4, another element for this first embodiment of the video game is that after the positive and negative stimuli 16, 18 are displayed, the user is then prompted to perform at least one action with the input means 5 in the immediate vicinity of the second region 19 where the positive stimulus was displayed. The user's focus is therefore directed to the region that displayed the positive stimulus and thus away from the region that displayed the negative stimulus. This embodiment of the video game may be programmed to minimize or eliminate the requirement that the user must perform a command with the input means in the immediate vicinity of the first region 17, the portion of the display where the negative stimulus 16 is displayed. This embodiment of the video game 8 may also be programmed to minimize focusing of the user's attention in the area in the first region 17 after the negative stimulus 16 is displayed in this region.

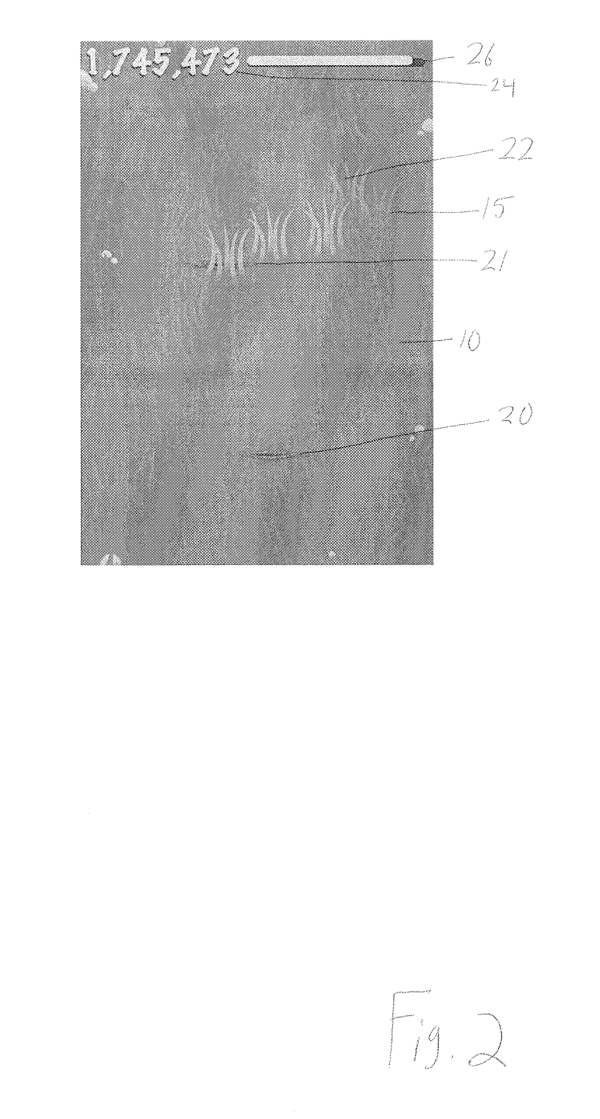

For example, in the first embodiment shown in FIGS. 1-2, after the negative and positive stimuli 16, 18 in the form of a happy sprite and an upset, scowling sprite are superimposed over the grass field 10, animations are presented wherein the sprites appear to each go into separate holes 20, 21 in the grass field in the first and second regions, respectively, immediately below the areas they were first displayed. A trail 15 of relatively long grass is then displayed as growing in a random orientation solely from the hole 21 that the positive stimulus 18, the smiling sprite, was displayed. The grass 15 may be presented in an animated form wherein the grass sways back and forth as if it is being blown by the wind.

The user is then required to input a command into the input means 5 which affects the trail 15 of grass. For instance, in a preferred variation of this first embodiment, the input means 5 is a touch screen and the user is required to trace the trail 15 of grass from the hole 21 to the end portion 22 of the trail of grass. As shown in FIG. 2, if the user touches a portion of the trail 15 of grass, that portion of the grass is illuminated. If the user traces the shape of the grass trail 15 from the hole 21 to the end portion 22 of the trail, the entire trail of grass becomes illuminated and the user then receives points for successfully tracing the trail of grass. In other variations of this first embodiment a musical tone or sequence is played to indicate that the user has successfully traced the trail of grass.

In order to keep the focus of the user primarily in the area in the immediate vicinity of the positive stimulus 18 and to avoid undue focus of the user's attention on the negative stimulus 16, the video game of the first embodiment may contain additional means to discourage or prevent an action to be performed in the immediate vicinity of the negative stimulus 16. For example, the user's input of an action in the input means 5 in the immediate vicinity of the negative stimulus 16 or in another incorrect region of the display or other output means 7 may result in a point deduction or the generation of a warning tone indicating that the input action was incorrect. Alternatively, the video game may be programmed to refuse to recognize any input action in the area in the vicinity of the negative stimulus or other incorrect regions.

The video game described in this first embodiment can have different variables and rules for scoring points to present a variety of challenges. For instance, in the example of the first embodiment shown in FIGS. 1-2, in addition to the changing of the orientation of the negative and positive stimuli 16, 18 the game can also modify the length and shape of the trail of grass, the time period required for the user to trace the trail of grass, or other variables known in the art.

In this first embodiment, a score 24 is displayed on a portion of the display and is calculated based on the user's success in performing the required objective. This provides the user with an enjoyable challenge and can result in an increasing immersion of the user's attention towards the game.

In preferred variations of the first embodiment, the module(s) of the device 2 count the number of times that the user successfully performs the objective of the video game. For example, in the first embodiment shown in FIGS. 1-2, the video game keeps a tally in a portion of the screen of the amount of times the user traces the grass trail 15. This tally is represented as, e.g., a horizontal bar 26 that moves closer to being filled each time the user successfully traces the path. When the horizontal bar 26 is completely filled, the video game displays a screen notifying the user that the session has ended. The user can then commence a new session with the computer 4 being adapted to count the number of sessions completed by the user each day and notify the user of such amount.

In this first embodiment, the continued presentation of the negative and positive stimuli 16, 18 with the user required to focus his/her attention on the area where the positive stimulus 18 was shown by entering a command with the input means 5 as part of the gameplay of the videogame, can result in a reduction of the user's cognitive bias to negative behavior. It is preferable that the user plays the therapeutic video game for periods of 40 minutes or more for increased therapeutic effect.

Importantly, this embodiment of the present invention involves an entertaining video game such that the user while playing the video game is provided with an engaging, enjoyable video game experience and the therapeutic aspects of the game may not be readily apparent to the user while playing the video game. The result is that the user can be compelled to play the therapeutic video game for longer periods of time and experientially the user may not be overtly aware that bias modification is being performed. This is a significant advantage over the prior art where threat bias modification is routinely performed in a laboratory setting with individuals that are keenly aware that psychological testing or treatment is being performed. This is also a significant advantage over the computerized version of the dot probe test where the experience also feels like psychological testing or treatment is being performed as the computer program limits the user to one of two choices in response to the display of stimulus and the objective is typically to solely perform identification by use of the input means.

This embodiment of the present invention may be incorporated into existing video games provided that the computer program encoding the video game is modified to present a positive and negative stimulus to the user in separate, discrete regions and the gameplay requires the user to view each stimulus while only paying significant attention to the region where the positive stimulus was displayed (or continues to be displayed) by performing a video game action in the immediate vicinity of the region where the positive stimulus was displayed or otherwise.

The video game shown in FIGS. 1-2 is just one embodiment of the video game content that provides the entertaining framework for administering ABMT.

A second embodiment of the present invention comprises a shuffleboard-like experience that requires a user to bounce an object around a playfield to score points.

In this second embodiment, a user is shown a board featuring a few stationary objects, and then two prompts briefly appear before turning into identical pucks. The user's job is to find the puck where the positive prompt appeared and to send it sliding around the field. Users score points as the puck bounces around the field, and their eventual goal is to fill up a progress bar to beat the level.

Each round of the game in this second embodiment is played on a unique randomized board. The stationary objects that appear on the unique randomized boards may come from a simple library of several basic shapes such as a triangle, a square, a long rectangle, etc. When each board is created, between 1 and 4 objects are selected and randomly placed on the board so that they don't overlap each other or the edge.

In this second embodiment, there are two random open locations on the board in which a positive prompt (symbolizing positive behavior) is shown in one, and a negative prompt (symbolizing negative behavior) is shown in another. Both prompts then turn into visually identical puck objects.

Once the pucks have been placed, the player can act. The puck that spawned on top of the negative prompt is a trick: if the player touches it, it doesn't move, as though it were glued to the floor. Whenever the player is touching the trap puck, the field may be turned red or “WRONG ONE!” (or something similar) may be displayed across the top of the screen.

The puck that spawned on the positive prompt is the live one. The player can slide it across the field by pressing down on it and then moving their finger in any direction. The puck shoots off in that direction immediately as though it were kicked, even if the player keeps their finger on the screen. This may be achieved by recording when the user first touches within the hit box of the live puck, and then recording where the user's finger is a fraction of a second later (or until it lifts off the screen), and then use this change in placement to create an angular momentum vector which is placed on the center of the puck and triggered. In a variation of the second embodiment, the player cannot guide or control the puck after that initial input. As soon as the player touches the live puck, the trap puck is removed from the field. There should also be a sense of “slide strength” so that if the player swipes slowly the puck slides gently, but a very quick initial swipe sends the puck off with more momentum.

The second embodiment of the present invention may use friction so that the puck will slow down and stop moving after a moment of time passes (for example 1-3 seconds). The puck can bounce off walls with standard simple 2D angular physics. When the puck bounces off a wall, 1 point (for example) is scored. When the puck bounces off an object, 5 points (for example) are scored. Whenever there's a scoring bounce, a small “+1” or “+5” prompt may be displayed which floats up from the point of the bounce and quickly fades away. On the left side of the field, a progress bar tracks the player's progress. In one variation of the second embodiment, the bar is a little unusual in that it starts full and goes down as the player scores points. For example the full bar can start at 50 units and goes down by 1 for every point the user scores.

During the period between when the prompts have become pucks and when the player sends the live puck in motion, the bar may be smoothly refilled at a constant rate of, e.g., 3 units per second. When the bar reaches zero, the player wins the round.

A third embodiment of the present invention comprises a timing game which requires a user to release his or her finger from a button at just the right time. This embodiment of the present invention may also have an optional breathing requirement that encourages the user to take deep breaths as they play the game.

In this third embodiment of the present invention, the user is shown two prompts side by side, which then turn into buttons. When the user touches the positive prompt button, a ring appears around their button, and then a second glowing ring begins expanding from the button. The user attempts to lift up their finger at the exact moment when the rings overlap. After the user lets go the glowing ring recedes back to the center of the button and the next round begins. The two prompts always appear in the exact same side-by-side locations; only their assignments (which is positive and which is negative) are randomized. The game quickly displays a positive prompt in one location and a negative prompt in the other. Then, both prompts are replaced with identical-looking buttons.

In this embodiment of the invention, the game lends itself to shorter display times for the positive and negative prompts so they may only be shown for small periods of time.

The button associated with the negative prompt is a dummy. If the user touches it, a red “X” is displayed over it. However, when the user touches the positive button, a “target” ring of a randomized size centered on the button is immediately displayed. The target ring size ranges are set so that the very largest size can go almost to the edge of the screen, and the smallest size can be about 2 seconds out from the button. Along with the target ring, a glowing ring is also created at the center of the button that expands automatically over time as long as the button is pressed.

As the glowing ring expands, the user can lift up their finger at any time to stop it. When the user lifts up their finger, the glowing ring is scored and then begins to automatically shrink back to the center of the button. When the glowing ring reaches the center of the button the user advances to the next round. When the button is lifted, the difference between the radiuses of the two rings is measured. The absolute value difference is measured, so that there is no difference between being 3 units too big and 3 units too small. This can be done using pixel measurements or another system of distance.

Scoring for this embodiment of the invention may be as follows: 100 points−(difference in ring sizes)²=total points. So if the rings are the same size, then the user will earn 100 points. If the rings are 2 units apart, then the user will earn 96 points (100−2²). If the rings are 5 units apart, the user will earn 75 points. The scoring structure for this embodiment is very simple: a user plays for 10 rounds and then their points across all 10 rounds are added up. A score “basement” may also be added to this embodiment so that if the user scores less than 5 points in a given round, the user is given a minimum of 5 points. Thus, even the worst possible round can earn the user 5 points.

A simple messaging feature may be built into this third embodiment of the present invention. This feature can be easily turned off so that the game can be played with and without it. This feature is as follows: whenever the glowing ring is expanding, the phrase “BREATHE IN” is displayed in large text across the top of the screen. When the ring is shrinking, “BREATHE OUT” is displayed across the top instead. Whenever the text is appearing or being removed from the screen, it can be faded in/out with a quick alpha fade.

A fourth embodiment of the present invention comprises an experience of tidying up a messy arrangement of objects. In this embodiment, users start with a dozen or so cards (8-12) scattered on a field. It is important that the cards appear scattered haphazardly rather than part of an orderly grid, and that the position and rotation of the cards is randomized. In each round a few of the cards are briefly “flipped over” to reveal either a positive prompt or a negative prompt. Gameplay requires the user to locate positive prompts. If the user finds one of the positive prompts, it is cleared from the field and the goal is to clear everything.

The field background onto which the cards are placed is a nice, interesting or pleasant image or pattern. It shouldn't be distracting or visually dominant, but it should be visible. The appearance of this embodiment should be that the cards look like they're getting in the way of the background. Different sources of art may be used for the background including: photographs, illustrations of characters, and simple abstract patterns.

In each round, two cards are randomly selected and are briefly replace with a prompt; one card is replaced with a positive prompt and the other card is replaced with a negative prompt. The size, location, and rotation of the prompts should match that of the cards exactly, as if the cards had been quickly flipped over and then back.

The user then taps a card. If the user selects either the card that was the negative prompt or a card that didn't show a prompt at all, the screen flashes red for a moment. The user can then select other cards. When the user does tap the positive prompt card (either as their first guess, or after many incorrect guesses), the positive prompt is shown again, and a quick star/sparkle image is displayed behind the prompt, and then the card/prompt is faded away entirely. That card is now gone and won't appear in future rounds.

Between each round, a simple animation is displayed to imply that the cards are shuffling around. This can be very simple, but it's important because users should not have to feel that their job is to remember the persistent locations of cards on the playing field. One example of a shuffle animation is to slide all of the cards into the center of the screen so they overlap, quickly have the cards fade to black, and then immediately fade the cards back to show them spread out as if they had been instantly dealt out on the table.

As the number of cards reduces over time, eventually there will be a point where there is only one card remaining on the field. In this final round, a positive prompt is displayed on the final card remaining so that it is impossible to get it wrong. When the player removes the last card from the field, they win the game.

This fourth embodiment has a basic version (described above), and three variations of the basic version. It is envisioned that in this embodiment these different versions may be automatically served-up as the user advances through the game.

The first variation is like the standard version described above except that in each round either 2, 3, 4, or 5 cards are flipped each round, rather than just 2. In this variation, at least one of the flipped card features a positive prompt, but otherwise there is randomness in the number of positive and negative prompts that are displayed: sometimes multiple positive prompts will be shown at once.

The second variation is also like the standard version except that there are many different positive images for the positive prompts, and many different negative images for the negative prompts. Photographs may be used in this version, as well as drawings or cartoons.

The third variation is also like the standard version except that words or phrases are used instead of images for the prompts. Also, a variety of different words or phrases are used for the positive and negative prompts (like in the second variation).

A fifth embodiment of the present invention comprises a simple and relaxing action game inspired by top-view infinite runners (a genre exemplified by games like Temple Run or Minion Rush) in which users travel along a path and are warned of upcoming hazards.

In this embodiment, the user controls a character moving down a straight randomized road. The road contains three lanes, and the user moves side to side between the lanes. The users are always running forward down the road automatically, so all that the user is managing is which lane they want to be in at any time.

The road is assembled out of a string of distinct “sections.” The user isn't necessarily aware of these sections, but they are key to the system. When a player first enters a section, there is an open period of free running featuring no rewards or hazards. After this open period ends, prompts are randomly shown on two of the three lanes. One is positive and the other is negative. After a brief period, a hazard is placed on the path that had the negative prompt and a reward is placed on the path that featured the positive prompt.

Users move between the lanes by tapping. The user can only move one lane at a time, per tap, so if the user is in the left lane and taps the far right lane, the user will move into the center late. Users are always moving forward at the same speed down the road, and they never move up or down on the screen.

Users earn, for example, 5 points per second as they run automatically, and when users collide with a reward, they collect it and earn, e.g., 500 points after which a calming and positive visual representation is shown.

When a user collides with a hazard, no points are earned, and a smoky puff visual representation is shown. From a score/success perspective, hitting a hazard is the same as hitting nothing (hazards are not intended to be punishing).

Each round in this embodiment lasts for around 30 seconds, and when the user reaches the end of the last section, the round ends.

A sixth embodiment of the present invention comprises a fluid game that requires continuous movement and focus. In this embodiment, users trace smoothly around the screen to keep their fingers inside of gently wondering circles. At the start of the game two prompts are shown which then turn into circles. Once the user puts their finger inside the positive circle, it begins to float smoothly around the space. As the user keeps their finger inside the circle, the user racks up points. Then, more prompts appear and the user must then hop onto the next positive circle. As the user earns more and more points a progress bar in the corner fills up and the background gradually shifts in color. When a user has filled the progress bar they win the round.

Two random non-overlapping locations on the board briefly flash a positive and negative prompt. The, the two prompts are immediately replaced with identical looking circles large enough so that a user's finger does not completely cover them up.

As soon as the circles are generated, they begin moving. The movement is fluid and rounded, not jerky or twitchy. The circles change speed as well as direction as they moves, speeding up and then gently slowing down. The movement of the circles is tuned so that it is a challenge for the user to keep their finger inside the circle as it moves. In a preferred version of this embodiment, the movement is tuned so that it is not so easy to track the circle that success is guaranteed, but not so hard that failure is constantly happening.

If the player touches the circle associated with the negative prompt, the circle is immediately shrunken and removed. If the player touches the circle associated with the positive prompt, the other circle showing the negative prompt is immediately removed. The circle where the positive prompt appeared then continues to float around, and the player attempts to maintain contact with it.

The moving circle (where the positive prompt appeared) has two visual states—a bright visual state that occurs whenever the user's finger is inside, and a darker visual state whenever a touch is not detected inside the circle. The bright visual state may also have a simple effect or animation, such as a series of faint rings smoothly pulsing from the edges.

In this embodiment, the moving circle continues to float around the board for a randomized period between 4 and 7 seconds. When there is 1 second left before a circle is scheduled to end, the next round of prompts are introduced. There will be a brief overlap when the circle from one round is onscreen with the circles from the next round.

Whenever a player has their finger inside an active circle, they score points. Points tick up one at a time, very rapidly. The rate at which points are generated over time follows a simple curve with a low ceiling—when a user first makes contact with a scoring circle, the user earns points slowly, then the rate increases quickly and smoothly so that after ½ a second the user is earning points more quickly, and then after another ½ second a maximum rate of point accumulation occurs and stays for the duration of time that a user maintains contact with the circle.

The scoring for this embodiment of the invention may therefore be as follows:

First Contact=5 points per second

After 0.5 Seconds=15 points per second

1 Second and Beyond=30 points per second

If a user breaks contact with an active circle, the user immediately stops earning points, but if the user then touches it again, the user starts to earn points again, but the rate for earning points (as described above) starts over so that the user has to “rev-up” the points for a second time.

In this sixth embodiment of the present invention, a progress bar is prominently displayed across the top of the screen and the progress bar fills left to right. As the user earns points, the bar fills up. Numbers are never displayed to users so they will have no idea exactly how many points they have, but rather just a sense of how full the bar is.

The maximum capacity of the progress bar is adjusted so that 45 seconds of average play will fill it. A small timer (displaying seconds) can be included in the lower right corner of the screen (not as a prominent element of the screen) for timing each game. As the numbers involved are never shown to the player, the progress bar's maximum value need not be a rounded-number value. When the progress bar is completed the user wins the game and the timer is stopped at that point.

In this sixth embodiment, the color of the background may be dynamically associated with the progress bar as a smooth gradient running from hot red (when the progress bar is empty) to a cool sky blue (when the progress bar is full), such that when the progress bar is 50% full, the background is a purple color.

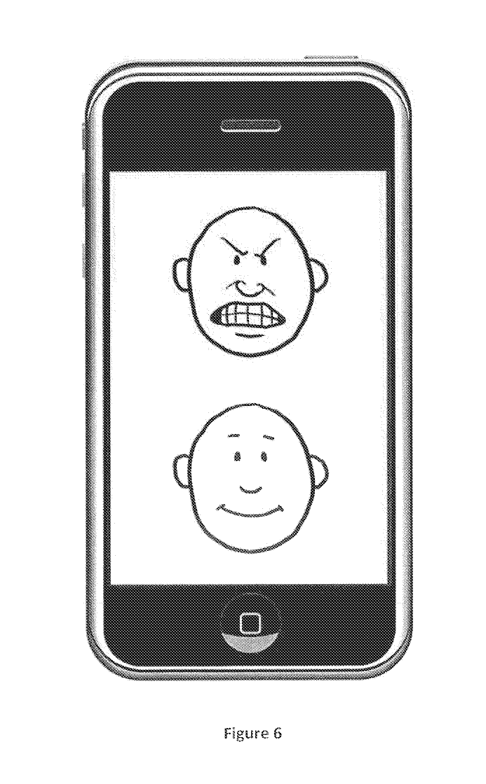

In a seventh embodiment, two faces appear, but instead of photographs they are illustrated and cartoonish: happy/neutral/good faces and mean/ugly/scary faces. Faces appear, quickly fade out, then a glowing ball is in the place of the neutral face—player taps it and then something fun happens: rainbows appear, unicorns, fly out, kittens jump across the screen, etc. Using more generic cartoon faces that distill the emotional landmarks but also remove indicators of race and gender may help remove areas of bias. There may be extra “face packs” that are purchased as upgrades (bug pack, alien pack, undersea pack, etc.). In this embodiment, the user is motivated to keep playing by the variety of faces and rewards. This embodiment is shown in FIG. 6.

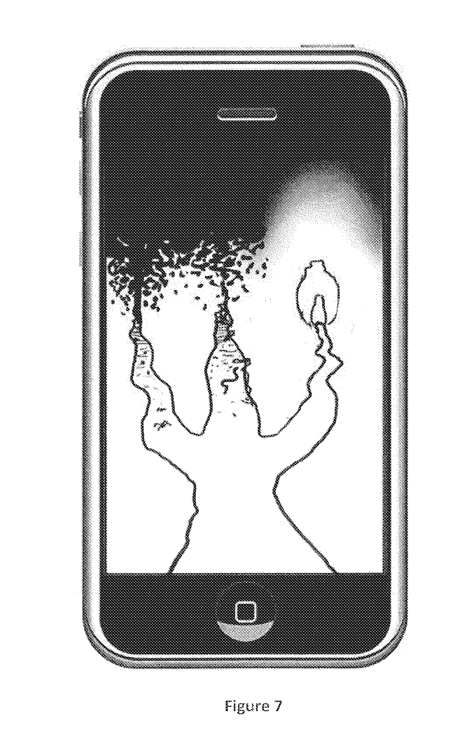

In an eighth embodiment, a user is presented with a path in a forest which forks ahead and where the user follows an angel/mysterious being/good person in the distance down one of the forks. The being appears as the paths disappear. The being is always at the end of the well-tended path—the other paths are full of thorns, snakes, dangers, etc. The user taps the being to reveal the next length of the journey. Paths may be randomly generated from a set of many variations, there is no end to the path, no score, no winning or losing. Generation of environments may be affected by actual time of day, or a user may choose from a few different lands/worlds. The user is motivated in this embodiment by a sense of exploration and making progress, and of being guided by a benevolent being. This embodiment is shown in FIG. 7.

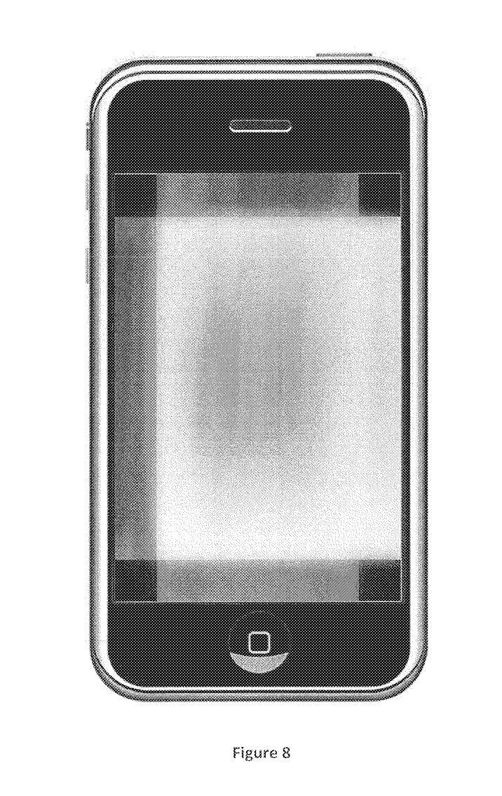

In a ninth embodiment, the center of the screen represents where the user is located within a maze. The user can swipe in any of the four directions to move. The user can see positive and negative things on the edge of screen which they can move towards (with corresponding soundscape). There are no repercussions for going towards the negative, only rewards for going towards the positive. As the user starts to pull toward another screen, he or she has the option to slide back. In a variation, the negative places are always dead ends, and moving to positive places leads the player out of the maze. These negative areas may include threatening scenes, faces, or creatures. Or they may be abstracted to a threatening color such as red with a noisy soundscape. Positive areas may have a calmer hue light blue, with consonant slow soundscapes. In this embodiment, the user is motivated to actively look for positive choices. This embodiment is shown in FIG. 8.

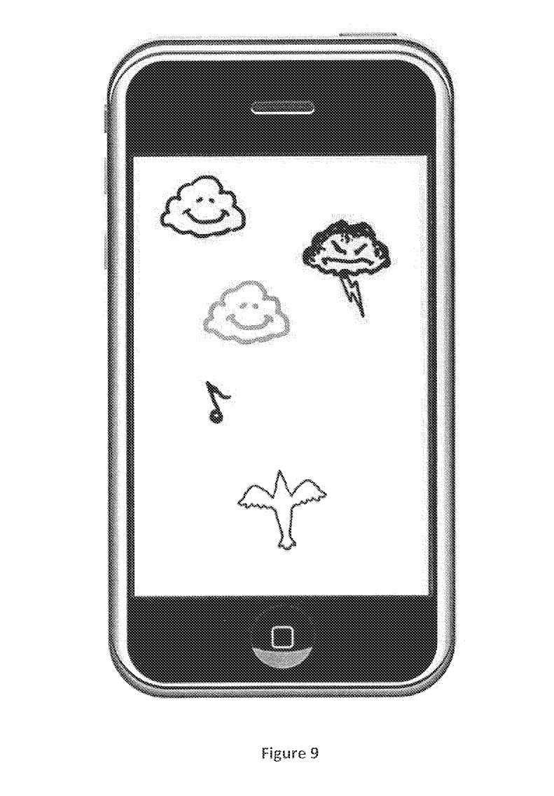

In a tenth embodiment, a user is a bird/flying creature/flying vehicle floating through the air, overhead view. The user's actions help generate the soundtrack. At the top of the screen, there appear happy clouds and mean clouds. These clouds fade and disappear as they get about halfway down the screen. Each good cloud dissolves into a musical note; each bad cloud dissolves into nothing. The user tilts the device left or right to move the bird towards the notes. Each time the user reaches a note, the melody moves along. In this embodiment, the user is motivated to keep the song going by moving towards the positive and ignoring the negative. This embodiment is shown in FIG. 9.

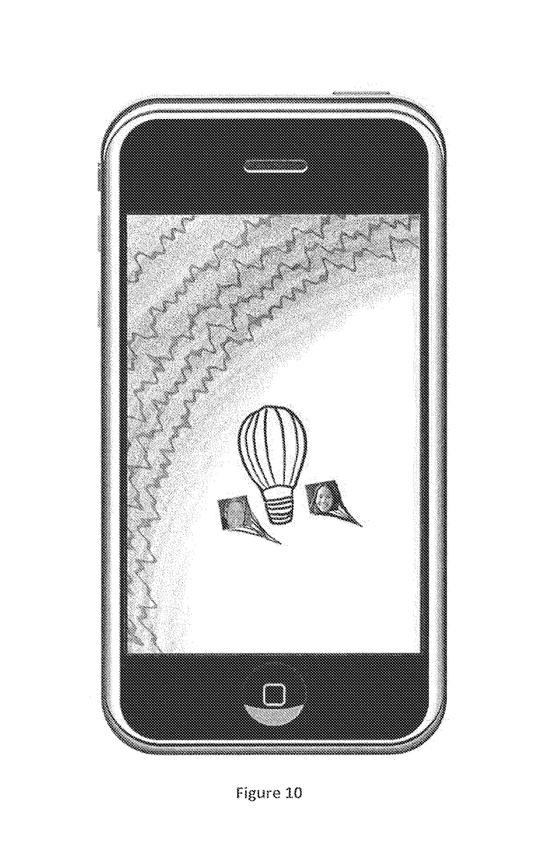

In an eleventh embodiment, a user is floating in a hot air balloon in the calm eye of a big storm. All kinds of nasties and threats are spinning around at the edge of the storm's eye. The user's goal is to move towards the center of the eye. Two other users appear as kites by the user's side, like guardians. If the user has, e.g., Facebook friends that are playing, the guardians can be chosen from them. If not, they are chosen/generated randomly. The guardians help point the way, and perhaps deflect debris. The guardians also dance or do something funny every time the player reaches the center of the eye. The storm's force eventually pulls the user out of the eye, so the user has to keep returning. There is only one score (accessed via the network), everyone helps each other to make it higher. In this embodiment, the user is motivated to move towards the calm center rather than the surrounding threats. The user is also motivated knowing that their friends have their back, and that they're all collaborating towards a common goal rather than competing against each other. This embodiment is shown in FIG. 10.

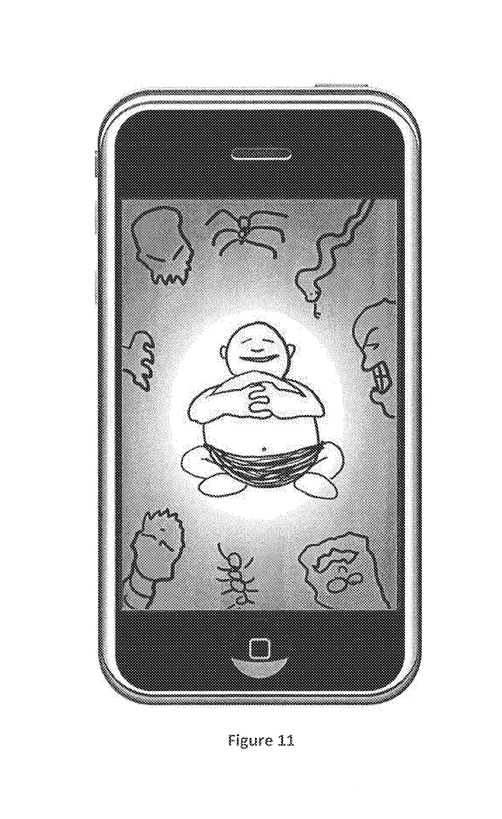

In a twelfth embodiment, a sleeping statue of a positive character is surrounded by little demons. The user taps the statue every time the statue reaches the end or beginning of a breath. This works like “tap tempo” on electronic music devices: the rate of tapping is set to the rhythm of music. The slower the music, the calmer things are. The faster, the more tense and threatening. In this embodiment, the user is motivated to focus on the calm, positive face rather than the surrounding threatening ones, and also to slow down, and to focus on breathing. This embodiment is shown in FIG. 11.

The above described embodiments are not intended to work together as a cohesive group of games, but they may be used together if desired. Furthermore, particular elements of the embodiments described above may be combined to produce a new type of game. For example, the scoring system of one embodiment may be combined with the moment-to-moment play of another embodiment. Also, the mechanics of the embodiments described above can be interwoven into other games that are separately developed. Thus, these embodiments may act as components that can be included in other games. Moreover, the particular scores or points described above are just examples, and may be modified.

The variables described in the above embodiments like timers, point rewards, or level of difficulty can be programmed to allow for easy changes where possible. Also, the embodiments of the present invention may use a variety of scoring mechanisms for monitoring a user's progress over a period of time such as daily progress rewards or achievements, and it is envisioned that the level of difficulty in the various embodiments may be increased as the user becomes more experienced in playing a particular game.

In addition to the various embodiments described above, the present invention may also take the form of many other widely popular video games genres in the industry, including first person shooters, role playing games, adventure games, puzzle games, platform games, matching games, etc.

Also, the present invention is adaptable for treating many different negative behaviors by having negative prompts that are representative of different negative behaviors (e.g., a sad face is representative of depression), and positive prompts that oppose the different negative behaviors (e.g., a smiley face opposes depression because it reflects a state of happiness).

An advantage of the present invention is that through the cognitive bias modification techniques described in the above embodiments users can experience a shift in how they interpret events (e.g., choosing a positive over a negative interpretation). These embodiments create competition in terms of interpretation, and thus train people towards a positive interpretation. An example embodiment would be providing a sentence completion task in which users are trained to generate positive interpretations, e.g., I gave a speech and the audience ______ (the correct answer is “applauded me” instead of “laughed at me”). The present invention can incorporate this example into a fun video game version or environment.

The embodiments described herein clearly show that the present invention is unique over a traditional dot probe test in several important aspects. A significant difference between the present invention and a traditional dot probe test is the user's required reaction to the positive and negative stimuli. The required reactions in the embodiments described herein is completely different than that of a traditional dot probe test: a traditional dot probe test requires a patient to press a button indicating the location of a “probe” stimulus whereas the gameplay of, for example, the first embodiment requires a user to trace a trail of grass after negative and positive prompts have burrowed into the grass. The other embodiments described above provide further examples of how the interaction between the user and the present invention is completely different than that of a patient performing a probe test.

Furthermore, the dot probe test has no game like characteristics (e.g., no points, no reward structure, and no achievements) such as those of the various embodiments of the present invention. Also, the gameplay of the embodiments of the present invention can include more than two stimuli displayed at once whereas a traditional dot probe test only displays two stimuli at a time. Moreover, the gameplay of the embodiments described herein can include abstract figures, cartoon characters, or sounds which are not present in a traditional dot probe test.

Another difference between the present invention and a traditional dot probe test is that a dot probe test requires that a patient respond to the location of the probes as an explicit instruction which can be correctly or incorrectly done. However, in accordance with the present invention, the user, for example, traces the grass and cannot move to the next trial unless they correctly trace the grass.

The use of the device 2 such as a smartphone or portable video game device provides a highly accessible, cost effective means to provide the video game. The therapeutic methods described in the above embodiments can be accurately and effectively performed without requiring the administering of ABMT by a professional and only requires the user to learn the gameplay of a particular embodiment and not any complex, psychological testing procedures.

Another aspect of the invention is a non-transitory computer-readable medium storing a program which when executed by at least one processor, provides a therapeutic video game as described above.

Another aspect of the invention is a method for providing a therapeutic video game to treat one or more of anxiety, stress, depression, addiction, eating disorders, lack of exercise, lack of self-esteem and other negative behaviors by providing a therapeutic videogame as described in the embodiments above.

The invention or any part(s) or function(s) thereof, including the device 2, the software module 6, and the game module 8, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, audio, and other data from the communication infrastructure (or from a frame buffer) for display on an output device 7. Example output devices 7 include the display unit, an audio device, etc. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

While the present invention has been shown and described with reference to certain preferred embodiments thereof, it will be understood by those skilled in the art that various changes in form and details may be made without departing from the sprite and scope of the invention as defined by the appended claims.

What is claimed is:

1. A therapeutic device comprising:
a computer having input means and a computer display;
software executing on said computer which provides a video game that is programmed to display a series of images representing an environment, wherein the software is adapted to change the display of the video game in accordance with the user's input of a command with the input means;
said software being programmed to simultaneously display a depiction of a negative stimulus in a first region of the computer display and a positive stimulus in a second region of the computer display;
wherein the software provides a series of objectives the user is required to meet within the video game;
wherein the objectives require the user to perform at least one action with the input means in the immediate vicinity of the second region of the display;
wherein the video game objectives do not require the user to perform any video game actions with the input means in the immediate vicinity of the first region of the display;
whereby playing of the video game results in a decrease of the user's cognitive bias to a negative behavior.

2. A method for treating comprising:
providing a video game for a computerized device that is programmed to display a series of images representing an environment;
providing input means which allow the user to input a command to the computerized device and the computerized device is adapted to change the display of the video game in accordance with the user's command;
displaying a depiction of a negative stimulus in a first region of the computer display and a positive stimulus in a second region of the computer display;
providing a series of objectives the user is required to meet within the video game by using input means, said objectives require the user to perform at least one video game action in the immediate vicinity of the second region of the display wherein the video game objectives do not require any video game actions to be performed in the immediate vicinity of the first portion of the display.

3. A non-transitory computer-readable medium storing a program, which, when executed by at least one processor, causes the at least one processor to perform the steps according to claim 2.
